(19) United States
(12) Patent Application Publication
(10) Pub. No.: US 2010/0219964 A1
(43) Pub. Date: Sep. 2, 2010

(54) Method and System for Detecting Faults in Sheet Material

(76) Inventors: Kevin G. Hunt, Hamilton (CA); William Lindsay, Hamilton (CA); James F. Stulen, Brantford (CA)

Correspondence Address: GOWLING, LAFLEUR HENDERSON LLP, ONE MAIN STREET WEST, HAMILTON, ON, L8P 4Z5, CA

(21) Appl. No.: 11/990,013

(22) PCT Filed: Aug. 1, 2006
(86) PCT No.: PCT/CA2006/001288

§ 371 Date: Feb. 5, 2008

Related U.S. Application Data
(60) Provisional application No. 60/705,438, filed on Aug. 5, 2005.

(51) Int. Cl. G08B 21/00; G01N 29/12

(52) U.S. Cl. 340/668; 73/579

(57) ABSTRACT

A method for detecting faults in sheet material, particularly folds in steel sheet which is being rolled to final specifications, consists in coupling a sensor which is sensitive to vibration in the rolling apparatus and monitoring an oscillating electric signal generated from the sensor to detect spikes which correspond to faults in the sheet material. A system for implementing the method is also provided.

### TECHNICAL FIELD

This invention relates to the detection of faults, which commonly occur during the rolling of metal to reduce the thickness of a slab to produce thin sheet or webs. In particular the faults occur during the coiling of the metal webs. The faults which can occur most commonly consist of a transverse fold or creases in the metal web, as well as longitudinal edge tears, crimps, over rolls, and other physical faults which may arise from the transfer of metal webs from the exit end of the rolling process, to the entry end of the web coiling operation.

### BACKGROUND ART

Sheet metal is rolled to its final thickness by passing a slab of material through a series of rolling stations, which consist of top and bottom rolls having a predetermined separation, the separation between rolls in successive stations gradually decreasing until the desired thickness is produced. The final thickness is determined by the reduction of a slab or transfer bar through a primary rougher and subsequent finisher rolling stands. The rougher does the major draft reductions, while the finisher does the final draft reductions. After the sheet has been rolled to a desired gauge or thickness, it must subsequently be coiled.

The rolling process is done at elevated temperatures for most metals and the strip is cooled on a run out table prior to coiling. Adequate cooling is critical to get the proper metallurgical properties prior to coiling. The final temperature of the web prior to coiling is directly related to the amount of heat which can be extracted from the web through cooling means, typically water sprays. This leads to some run out tables being quite long. In general, hot mills have a long separation (typically 100 or more meters) between the exit end of the final rolling stand and the coiling process where the web is rolled up into a coil. Upon exiting the final rolling stand, the web moves in a horizontal direction at high velocity and is essentially in free flight and physically unrestrained between the last stand and the coiling process entry point where the strip is engaged by the coiling apparatus. The only physical force keeping the strip from flying off the surface of the run out table is the force of gravity and the downward pressure of the cooling water sprays which flood the surface of the moving strip. The use of long run out tables increases the chance of a fold defect occurring in a strip, prior to the coiling operation, as the strip can make random contact with run out table transfer rolls, which can result in random tears, kinks or strip folds in the moving strip as it is transferred to the coiler. In the case of steel hot rolling, exit temperatures from the final rolling stand can be in the order of 1000° C. and final coiling occurs anywhere in the ambient to 800° C. range, depending on the required metallurgical properties of the product. Physical defects produced during the coiling of a hot rolled strip product are most prominent at the beginning and end of the coiling sequence. The middle section of the coil is normally at a steady state condition, with the coiler maintaining a constant strip tension, pulling the material from the exit end of the rolling mill into the coiling apparatus. The start of a strip coiling sequence has metal passing from the rolling (gauging) mill to the coiler without the presence of strip tension. During the critical time between the point where the leading end of the strip leaves the last rolling stand and until it enters the coiler mandrel, where take up tension is established, it is very easy for the strip to fold over on top of itself in localized areas creating a kink or fold, should the rolling mill deliver material too quickly to the coiler or should the strip make physical contact with the transfer rolls or side guides. Once rolling is completed and the tail end of the strip emerges from the exit end of the rolling mill, it is no longer restrained by rolling mill inter-stand tension and it flies down the run out table unrestrained. As a result, strip trail ends are subject to random bruises, fold over and tears, since there is no tension control on this material, prior to it being drawn into the coiler at high speed. Similarly, the uncontrolled trail end of the strip creates a “whipping, snaking or slingshot” tail, exhibiting random vertical and horizontal movement, as it passes down the run out table and is drawn into the coiling apparatus. Similar coiling operations are used by other metal sheet producers such as aluminum, copper etc.

It should be noted that the environment near the coiler is usually very hot, moist, dusty, and humid. Steam rising off the hot rolled strip is a common occurrence. There are also usually very fine scale particles (metal oxide) in the air making it a very aggressive and challenging environment for any sensing equipment to operate and survive.

At the entrance to the coiling apparatus, there is a set of pinch rolls consisting of an upper moveable roll and a lower fixed roll, which are used to maintain tension between the coiler and the coil take-up mandrel, when strip tension is not established between the mandrel and the exit end of the finishing stand. The pinch rolls help guide the leading end of the strip into the coiling apparatus and provide a restraining force, sufficient to allow the mandrel to achieve tension on the lead end of the strip and the initial coil wraps. Their fundamental purpose is to maintain coil tension at the beginning and end of the strip coiling sequence. Constant tension is required on the coil take up-mandrel, contained in the coiling apparatus. Movement of the upper pinch roll, as a result of direct contact with physical strip defects can range from a small to a large deflection of the moveable pinch roll. In this invention, detection of the increased separation of the upper pinch roll from the lower pinch roll due to the passage of extra layers of material through the pinch roll bite is accomplished by the movement of an accelerometer attached to the moveable pinch roll drive train, which can include the bearing housing, motor drive armature or various locations on its supporting drive framework. The unidirectional accelerometer is preferably positioned in parallel with the direction of the moveable pinch roll motion to be effective, so that when excess material passes through the pinch roll opening, the movement of the moveable pinch roll will result in a vibration signal generated by the accelerometer.

Once coiling tension has been established between the mandrel and the exit end of the rolling mill, the non-fixed or moveable pinch roll is lifted off the strip and positioned above the lower fixed pinch roll, over which the tensioned strip passes as it enters the coiling apparatus. To detect mid-coil folds, tears and seams, the non-fixed roll is mechanically suspended above the moving strip, so that there is a very narrow defined gap between the strip and the non-fixed pinch roll. If material having a thickness greater than the gap is encountered, the moving strip makes contact with the non-fixed roll, causing a deflection of the roll due to defect impact, which is subsequently detected by the accelerometer. Wavy strip edges cause a fluttering, intermittent signal to be generated by the accelerometer, while folds or edge tears may be signaled by either an instantaneous or a continuous “rumbling” vibration signal. Once the end of the strip leaves the exit end of the rolling mill, it is no longer under tension and the non-fixed pinch roll is again engaged to maintain adequate strip tension, as the trailing end of the strip enters the coiling apparatus. At this point in the coiling sequence, the trail end of the strip is free to move unrestrained, so the incidence of folding and tearing is accentuated as the strip moves down the run out table and is drawn into the coiling apparatus. Once the trail end of the strip has passed through the pinch rolls, the non-fixed pinch roll is raised and held in a position to be re-engaged, when a subsequent strip exits the last stand of the rolling mill and makes its way down the run out table to the coiling apparatus.

The purpose of the detection system is not to detect the type of defect present, but to determine the presence and location of a defect within a coil body, so that it can be subsequently examined and removed by inspection staff although to an experienced operator, the raw data provides a visual image that is representative of the defect type.

Other Detectors:

LVDT—Linear Velocity Displacement Transducers are an alternate way of monitoring vibration in a coiling apparatus, however the LVDT sensors are delicate in construction and typically can not survive the severe equipment vibration and environmental contaminant (e.g. iron oxide particles and dirt debris) which accumulates on the external sensing rod. LVDT pinch roll frame lift air cylinders with integrated sensing rod units as part of their internal components are commercially available. However, these units are expensive and are not readily accessible for maintenance, without changing the entire cylinder housing. Resolution of the LVDT signal is also a problem as it has a limited distance range.

Air Pressure Detectors—These sensor systems have been used successfully in Japan (patent #JP0397514A). The problem with this system is that the pneumatic cylinders typically leak air through their seals, after being in service for a short period of time in the typical industrial environment of a rolling mill. Consequently, all cylinders must have additional air pressure (float pressure) supplied to make up for the shaft seal leaks. A characteristic of air pressure detectors is that they often drop air pressure in the pneumatic system, when a pinch roll impacts a fold or strip defect and the resultant introduction of make-up air into the cylinders often masks the pressure drop caused by the defect of interest. This hides defects and results in a detection system with low sensitivity. Air systems are also subject to system accumulations effects from volume increases and hose flexing, which also masks small air pressure changes indicative of defects. Gross defects can be detected, but subtle ones are missed.

Proximity Probes—These detection systems can include the family of ultrasonic, visible, laser and radar electromagnetic energy wave sources. The problem with all of these highly sensitive systems is the survivability of the sensor/detector in the process environment. Both heat and moisture can affect the quality of the detected signal, with ambient steam from strip cooling water being the leading cause of signals not being detected and transmitted properly to the defect monitoring station caused by adsorption or reflection of the energy spectrum by atmospheric interference. Currently there are proximity probes commercially available, which can be mounted further away from the process to improve survivability, however the accuracy and resolution of the signal is degraded and often lost due to their remote sensing location. Long-range sensors are even more susceptible to problems resulting from steam blocking signal detection.

FFT—Fast Fourier Transform vibration monitoring—The operating vibration of a coiler changes constantly, depending upon product characteristics, making the volume of background data “noise” detected large and much more complicated to analyze, due to machine harmonics and the equipment's natural frequencies. This method of analysis works reasonably well, but requires much more computer analysis power to resolve defect signals.

This invention has a much quicker alarm response than FFT, since very little computational analysis is required to resolve the signal from the background vibration.

Typically, rolled and coiled sheet products are inspected for defects by visual inspection at the coiling operation, by manually examining the coiled sheet product. Detected defects may be repaired either onsite or at downstream operations. Defects detected in the outer wraps can usually be fixed in the immediate vicinity of the coiling apparatus, by removing damaged outer coil wraps. Defects detected in the leading end of the coiled steel (initial wraps located within the eye of a coil) are usually repaired at downstream operations or on a rewind line after the entire coil is unwound for inspection. Any damaged areas of the coil are subsequently scrapped. Undetected faults in the rolled sheet, not detected in inner or outer wraps are often accidentally detected downstream during subsequent processing operations. The emergence of these unexpected defects pose a serious problem resulting in strip breakage, equipment damage, and potential operator injury. This type of defect also results in an increase in the amount of waste scrap with a significant reduction in the value in the coil product. Defects which pass through the process undetected and reach the customer usually result in a claim for compensation, which is a very expensive method of doing defect inspection, since rejected coils have to be shipped back to the manufacturer, incurring additional transportation and labor costs, over and above the scrap losses.

Faults in the rolled sheet are often detected in downstream operations after the sheet is coiled and depending on the location of the fault, line breakage or equipment damage, injury may occur. Damaged areas of the coil will be scrapped.

All such actions inevitably result in down time, which is costly to the manufacturing facilities. When faults are not detected, the sheet cannot be processed in the normal way. Equipment can be damaged and injuries to personnel can also occur.

An object of this invention is to a provide a means for detecting faults, which may occur during the dynamic coiling of sheet material, so that corrective action may be taken before the coiled sheet is processed further.

### DISCLOSURE OF INVENTION

In accordance with this invention, there is provided a method for detecting faults in sheet material, which is generally uniform in cross-sectional thickness. The sheet material is transported longitudinally between at least one pair of pinch rolls disposed for rolling contact with the moving the sheet material. To perform the invention, a sensor responsive to vibration frequency is coupled to apparatus associated with the pinch rolls. The sensor is responsive to instantaneous directional vibration in said apparatus, such vibration having sufficient force to generate an electric signal when the thickness of the sheet material received between the pinch rolls exceeds expected specifications.

Typically, in the rolling of steel sheet, only the end of a coil has the pinch rolls maintaining strip tension with a coiling mandrel for wrapping the sheet to form a coil, as otherwise strip tension is maintained between the coiling mandrel and other upstream feed rolls. Most strip folds occur at the start and end of coiling. A signal indicating that tension has been established with the coiling mandrel is used to determine when to look for elevated signals. Signals above a set threshold trigger a response and are classified as potential defects in the coiling strip. If the pre set threshold is exceeded, the operator is signaled to one of three conditions regarding defect location: head end, body or tail end of coil. Each type of defect tends to have a unique pattern. This characteristic “fingerprint” information is available for a trained user who can manually reviewing the raw data after a coil has been sent for inspection. This signal can be combined with a distance signal to provide the operator with the exact location of the defect in either the head or tail of the strip.

### BRIEF DESCRIPTION OF DRAWINGS

In order that the invention can be understood, a preferred embodiment is described below with reference to the accompanying drawings, in which:

FIG. 1 is a schematic representation of a rolling mill;

FIG. 2 is a side elevation view of coiling apparatus forming part of the rolling mill of FIG. 1;

FIG. 3 is a side elevation view of drive trains for pinch rolls forming part of the coiling apparatus of FIG. 2 showing a preferred location for a sensor;

FIG. 4 is a graphical display showing a normal trace for steel sheet passing through coiling apparatus and displaying a tension established signal, jack position signal and fold detector signal;

FIG. 5 is a graphical display showing output voltage from the fault detector according to the invention with exemplary fault consisting of a fold in a head portion of rolled steel sheet;

FIG. 6 is a schematic drawing illustrating a fold-type fault in a rolled coil of steel sheet;

FIG. 7 is a graphical display showing output voltage from the fault detector according to the invention with exemplary fault consisting of a fold in the body portion of rolled steel sheet;

FIG. 8 is a graphical display showing output voltage from the fault detector according to the invention with exemplary fault consisting of torn edges in a tail portion of rolled steel sheet;

FIG. 9 is an illustration of a telescoping coil fault in steel sheet;

FIG. 10 is a graphical display showing output voltage from the fault detector according to the invention with exemplary fault consisting of a telescope in a tail portion of rolled steel sheet;

FIG. 11 is a graphical display showing a normal trace for steel sheet passing through coiling apparatus and displaying a tension established signal, a jack position signal which starts in a lower position and a fold detector signal showing a head end impact which can be ignored; and

FIG. 12 is a schematic representation of a system for detecting faults in sheet material in accordance with the invention.

### BEST MODE FOR CARRYING OUT THE INVENTION

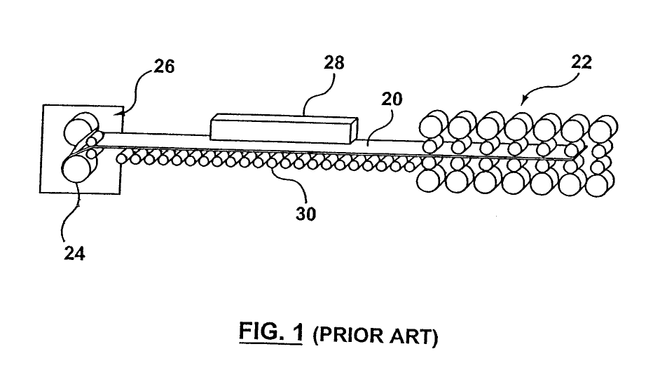

The invention will be described with reference being made to the rolling and coiling of steel sheet as shown schematically in FIG. 1. As drawn, the steel sheet 20 exits to the left of a rolling mill 22 where it has been rolled to the desired thickness by upstream feed rolls and is coiled on a coiling mandrel 24. Between the rolling mill 22 and coiling apparatus 26, the steel sheet is cooled by water sprays 28 on a long horizontal run out table 30 consisting of a series of rolls disposed side by side.

Each coil has a finite length and faults are often associated with the start of coiling when the leading edge of a sheet of steel enters the coiling apparatus 26 and before it engages the coiling mandrel 24 whereupon the sheet will be under tension. Faults also commonly occur at the trailing edge of a sheet of steel after it has been released from the rolling mill 22.

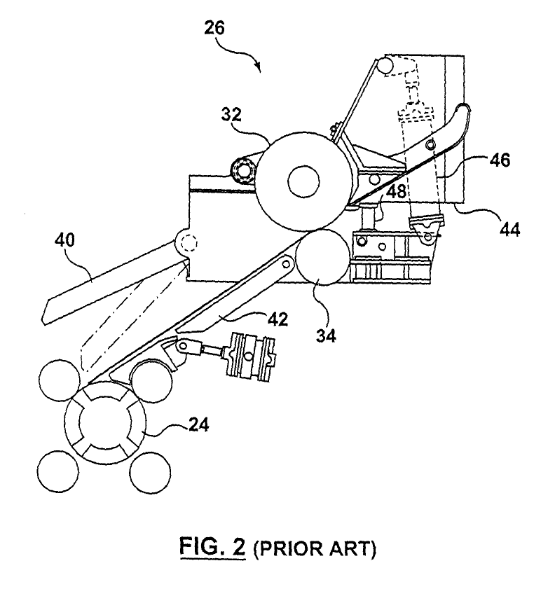

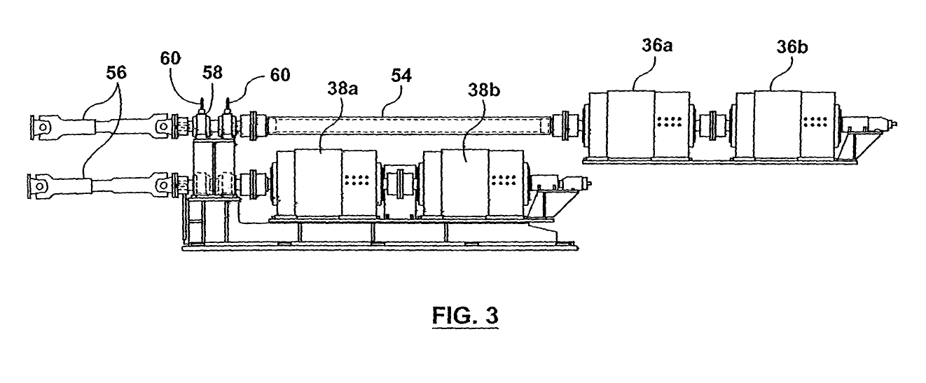

The coiling apparatus 26 is shown in more detail in FIG. 2. In order to guide the steel sheet 20 and feed the coiling mandrel 24, the leading edge of the sheet 20 is pinched between a pair of pinch rolls consisting of an upper moveable pinch roll 32 and a lower fixed pinch roll 34. The top pinch roll 32 typically has a diameter of thirty-six inches and is a hollow cast iron alloy roll. The bottom pinch roll 34 is made of forged steel and typically has a diameter of sixteen to eighteen inches. Both rolls 32, 34 are individually driven by reversible d-c motors 36, 38 (FIG. 3). The large top roll 32 is positioned on the delivery side of the bottom roll 34 to facilitate guidance of the steel sheet 20 into upper and lower throat guides 40, 42 adjacent to the coiling mandrel 24.

The top pinch roll 32 is pivotally mounted to a frame 44 and its position relative to the bottom pinch roll is regulated by a pair of pneumatic cylinders 46, only one of which is seen in FIG. 2. A pinch roll gap is established by lowering the top pinch roll frame 44 against two motor driven jacks 48 (only one of which is seen in FIG. 2) to set the proper separation for the product being rolled.

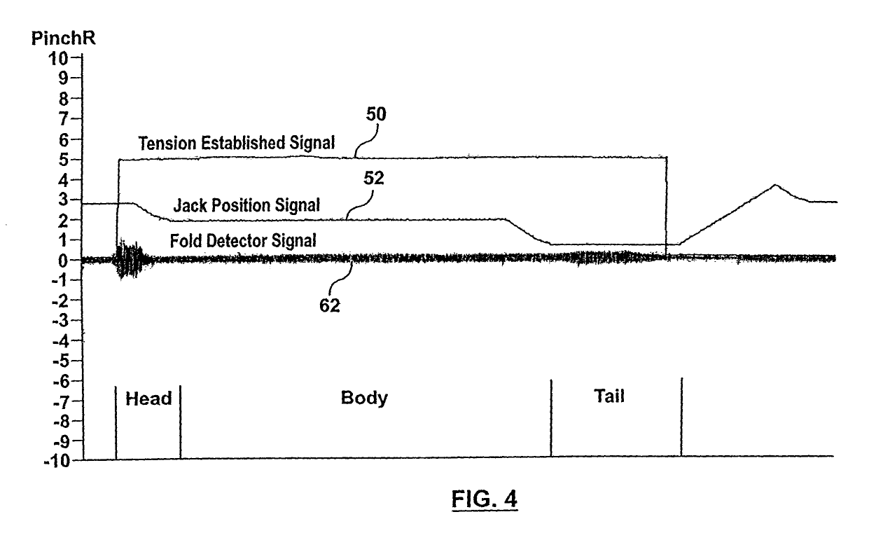

During a typical rolling process, the jack position is monitored and adjusted to assist in the coiling process. At the start of a cycle, the jacks 48 are in an elevated position, spacing the moveable pinch roll 32 from the fixed lower pinch roll and the leading free end of a coil is guided onto the coiling mandrel 24. Once tension is established in the steel sheet 20, the jacks 48 are positioned in tandem with the pneumatic cylinders 46, 50 so that the moveable pinch roll 32 is in a so-called “floating” position spaced as close as possible without touching the steel sheet. At the end of the cycle, the jack 48 is lowered to a pre-defined minimum separation for the pinch rolls 32, 34 corresponding to the gauge thickness so that the upper pinch roll 32 makes contact with the steel sheet 20 and maintains the sheet tension with the coiling mandrel 24. The three stages of coiling the head, the body, and the tail of a steel strip are shown in FIG. 4 with corresponding signal traces showing a tension established signal 50 and jack position signal 52.

Returning now to FIG. 3, the drive trains for the pinch rolls 32, 34 are shown. Each pinch roll is driven by respective motor sets consisting of two motors (36a, 36b, 38a, 38b) tandemly coupled to a respective direct drive shaft 54 with universal joints and a universal drive shaft 56 coupling the drive trains to the pinch rolls 32, 34. A pillow block bearing 58 couples the universal drive shaft 56 and direct drive shaft 54.

In accordance with the invention, an accelerometer or sensor 60 such as Wilcoxon Research Model 786A (100 m v/g) is mounted to the pillow block bearing 58 for the upper moveable pinch roll 32 and oriented for movement having a vertical component. In the embodiment illustrated, a back-up sensor 60 is shown on a second pillow block bearing 58. The sensor 60 is preferably associated with the drive train remote from the mounting frame 44 in order to prolong its useful working life. It will be noted that the sensor 60 may also be mounted to apparatus associated with the lower fixed pinch roll 34 but the resulting oscillating electric signal generated from the sensor 60 may exhibit a lot of background “noise” not associated with a fault in the steel sheet 20.

A graphical representation of a typical oscillating electric signal 62 generated by the sensor 60 is shown in FIG. 4 over the same time period that a tension established signal 50 and jack position signal 52 are generated. The oscillating electric signal is labeled in the graph as “Fold Detector Signal”. This is a normal trace showing some increased vibration at the head end of the steel sheet immediately after the tension has been established with the coiling mandrel 24.

### INDUSTRIAL APPLICABILITY

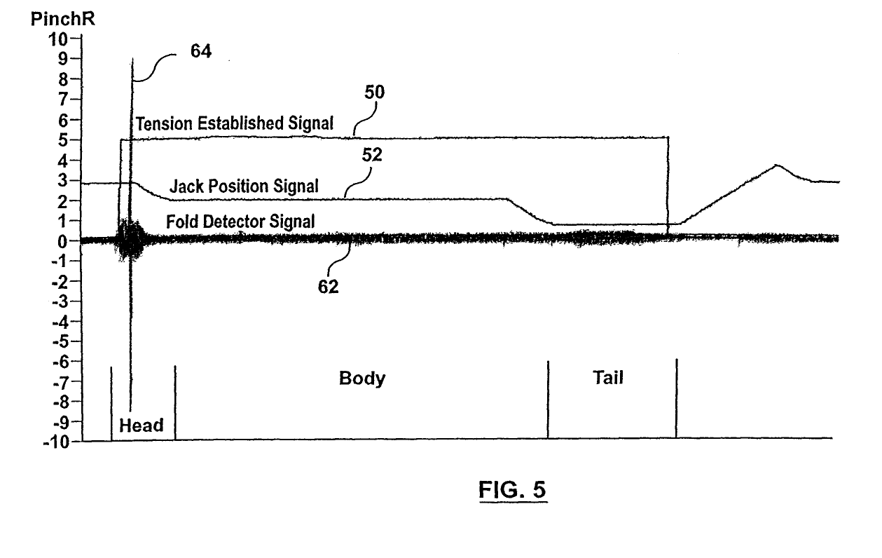

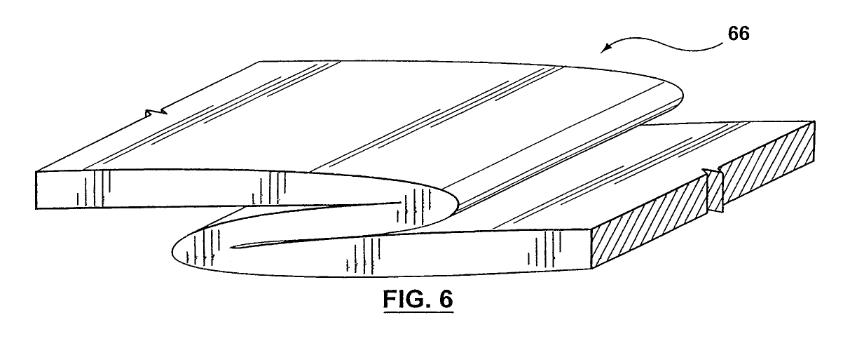

FIG. 5 shows another graphical representation displaying the tension established signal 50, jack position signal 52 and fold detector signal 62. A spike 64 in the fold detector signal 62 is shown occurring at the head of the steel sheet immediately after the tension established signal 50 shows a positive value and before the jack position signal indicates lowering of the jack to bring the moveable pinch roll 32 to a floating position. The spike 64 corresponds to a fault in the steel sheet 20 which has the form of a “fold” 66 as schematically illustrated in FIG. 6.

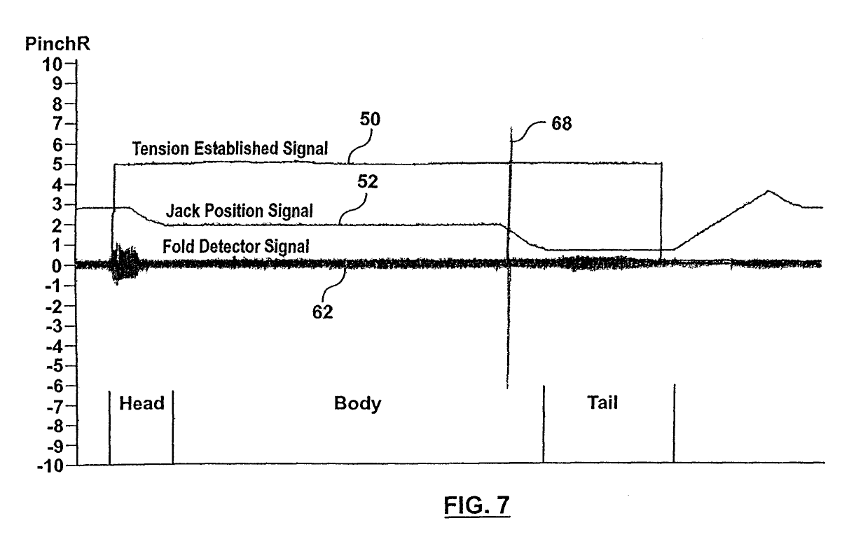

FIG. 7 is a graphical representation similar to FIG. 6 displaying a spike 68 in the fold detector signal 62 which occurs in the body of the steel sheet while the jack position signal 52 is being lowered to allow the moveable pinch roll 32 to make contact with and pinch the steel sheet 20 in order to maintain tension with the coiling mandrel 24. Here a fold will have occurred in the body of the coiled steel sheet.

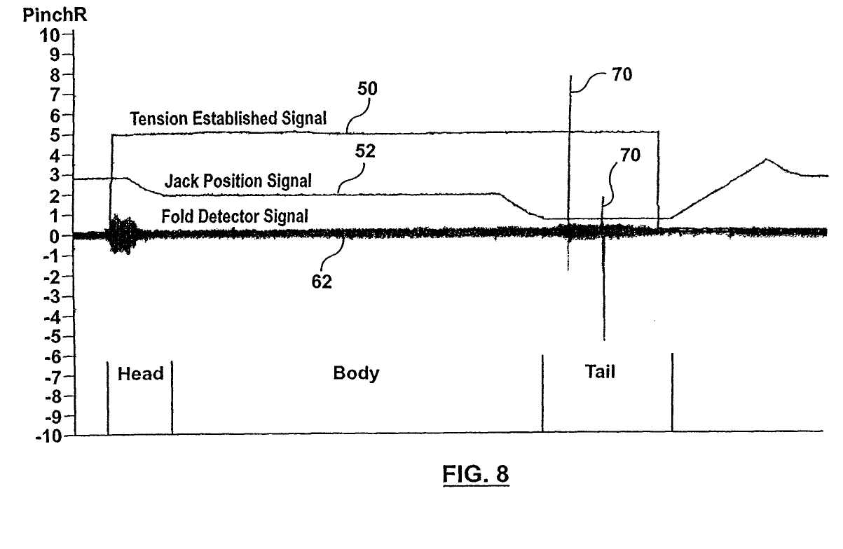

FIG. 8 is a graphical representation similar to FIG. 6 displaying a double spike 70 in the fold detector signal which occurs in the tail end of the steel sheet after the jack position signal 52 shows that the jacks 48 have been lowered.

The double spike 70 may be indicative of a fault which corresponds to torn edges in the tail end of the steel strip being coiled.

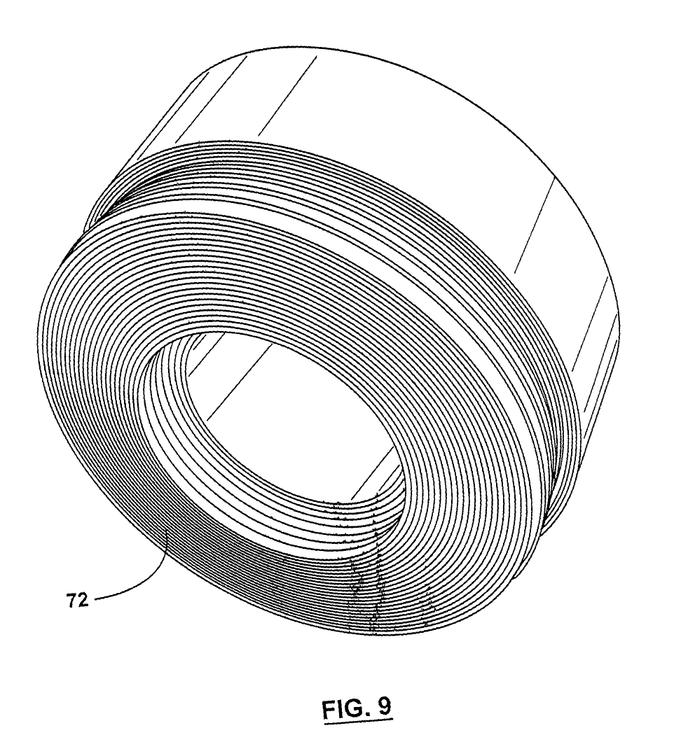

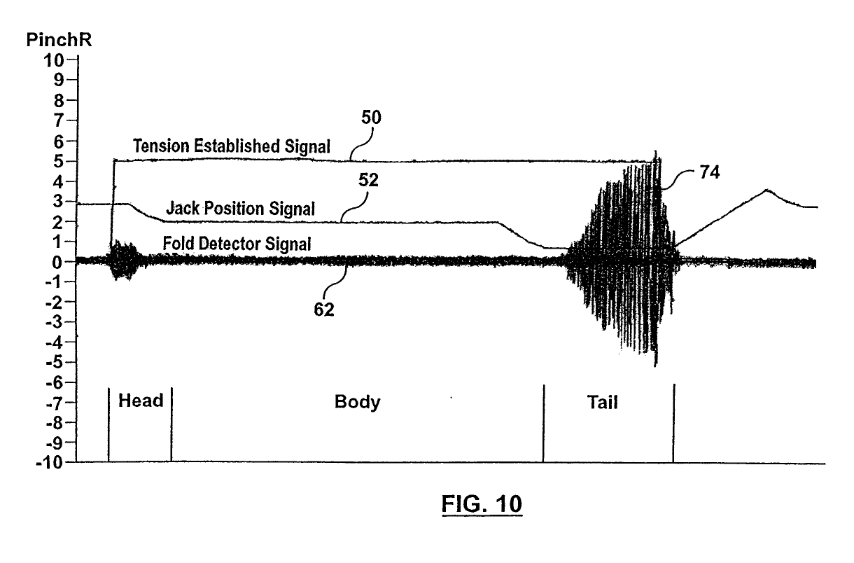

The fold detector signal 62 will manifest dramatic frequency changes indicative of faults which may be extreme such as a telescoping coil 72 (FIG. 9), illustrated by the graphical representation of FIG. 10 in which the fold detector signal 62 shows a plurality of spikes 74 in quick succession at the tail end of the coiled steel sheet.

More subtle faults such as “pencil line folds” resulting from a fold which unwraps itself but leaves either one or two distinct creases in the steel sheet are also manifested in the fold detector signal trace 62. It will be understood that the nature of the faults which may be detected by the invention will vary considerably and that no limitation is intended by the examples given above. Other faults which have been detected by the invention include those which may be understood as falling in the following categories of faults known to those skilled in the art as: crimps, wavy edge, central buckle in addition to those already mentioned.

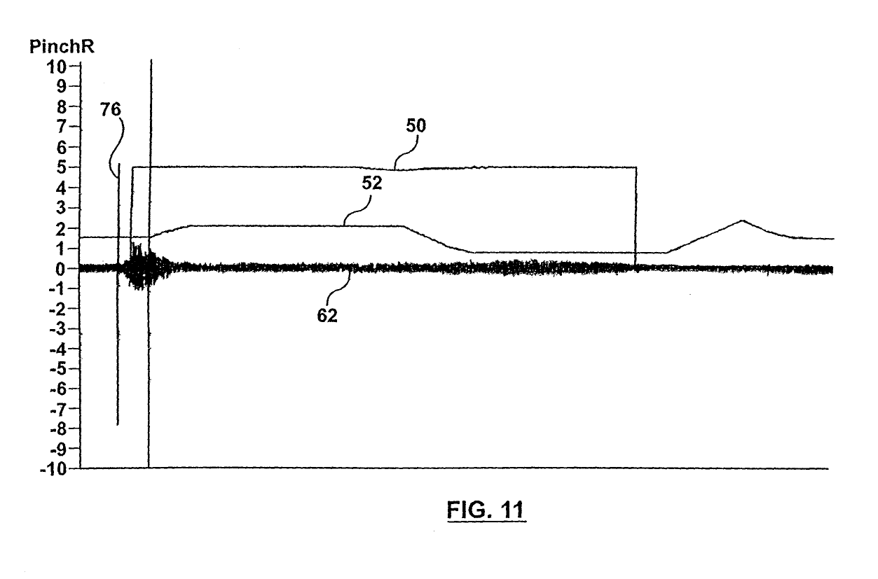

It will be understood that the tension established signal 50 and jack position signal 52 are indicative of processing conditions which may vary from product to product and which help in the interpretation of any variations in the fold detector signal 62 which are above a pre-determined threshold value. In the environment of a steel mill where the invention has been tested, it has been found that a minimum threshold of 4.5 volts is sufficient to detect even smaller faults such as pencil line folds.

Where the product being rolled demands that the jack position be lowered to more positively guide the leading end of a sheet of steel into the throat guides 40, 42 of a coiling mandrel 24, the jack position signal 52 will start low before being raised to the normal float position. Such a situation is illustrated in FIG. 11. Because of the specific processing conditions, the spike 76 displayed by the fold detector signal 62 before the tension established signal 50 shows a positive value may be ignored. The spike 76 is indicative of an impact at the head end of the steel strip as it progresses between the pinch rolls 32, 34 but is not indicative of a fault present in the rolled steel sheet 20.

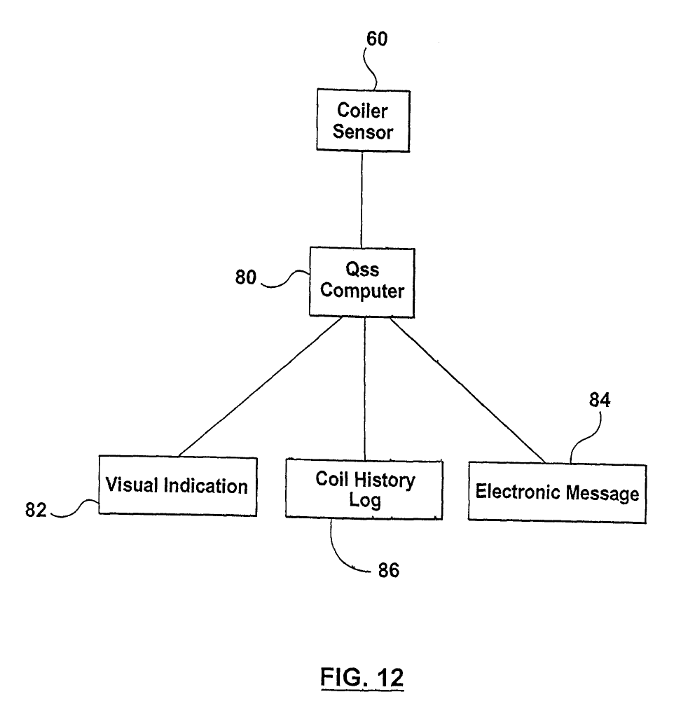

The graphical representations described above form part of a system for implementing the invention which is schematically illustrated in FIG. 12. The system 78 includes a number of sensors 60 each associated with a respective coiling apparatus 26. The sensors 60 each have an electric output in the form of an oscillating electric signal which is measured in voltage and which has a frequency corresponding to the vibration frequency of the associated apparatus.

The output from the sensors 60 is processed by a central computer 80 which also receives signals indicative of the tension established at the coiling mandrel 24 and the jack position which determines the separation between upper (moveable) pinch rolls 32 and lower fixed pinch rolls 34.

The computer 80 is programmed with Quality System Software (QSS) to recognize when the fold detector signal exceeds a threshold value and to display graphical results of the kind shown and discussed above with reference to FIGS. 4, 5, 7, 8, 10, and 11. A first level alert may therefore be a simple visual display or audible alarm indicated by reference numeral 82.

To minimize the need for any human interpretation of the display 82, the computer 80 may also be programmed to send an electronic message 84 to alert maintenance personnel that a threshold has been exceeded in accordance with the prevailing processing conditions, that is, recognizing whether tension has been established and the position of the jacks for the type of steel being processed. Supplementing the electronic message 84, the computer 80 may also generate a coil processing history log 86.

In accordance with another aspect of the invention, the system 78 may be provided with velocimeters positioned ahead of the pinch roll and at the exit of the strip mill whereby the instantaneous speed of the strip at the head and the tail may be estimated and the strip position in the system can be represented by a distance measurement trace superposed over the graphical output showing tension established signal 50, jack position signal 52 and fold detector signal 62. In this way, the location of any defects may more easily be determined for visual inspection of the strip coil.

It will be appreciated that several variations may be made to the above-described preferred embodiment of the invention with the scope of the appended claims and that the invention is not limited in its application to steel processing but may also find application to detecting faults in other sheet material or webs including woven materials, felts and papers.

1. Method for detecting faults in sheet material which is generally uniform in cross-sectional thickness, the sheet material being transported longitudinally between at least one pair of pinch rolls disposed for rolling contact with outer surfaces of the sheet material, the method including the following steps:
coupling a sensor to apparatus associated with said pinch rolls, said sensor being responsive to vibration frequency in said apparatus to generate an oscillating electric signal of corresponding frequency when the thickness of the sheet material received between the pinch rolls exceeds specifications;
monitoring said electric signal to ascertain whether it exceeds a predetermined threshold value associated with the presence of a fault in the sheet material; and
generating an alert when said predetermined threshold value is exceeded.

2. A method according to claim 1 in which the sensor is an accelerometer.

3. A method according to claim 1 in which the oscillating electric signal generated is voltage.

4. Method according to claim 1 in which the sensor is coupled to a mounting frame for the pinch rolls.

5. Method according to claim 1 in which the sensor is coupled to a pillow block bearing forming part of a drive train for an upper moveable pinch roll and is oriented for movement having a vertical component.

6. Method according to claim 1 in which the alert is expressed in the form of a graphical representation of the electric signal over a period of time.

7. Method according to claim 1 in which the alert is expressed in the form of an electronic message directed to maintenance personnel.

8. Method for detecting faults in sheet material which is generally uniform in cross-sectional thickness, the sheet material being transported longitudinally between at least one pair of pinch rolls disposed for intermediate rolling contact with outer surfaces of the sheet material and a coiling mandrel for wrapping the sheet material to form a coil, the pinch rolls including a moveable pinch roll moveable relative to a fixed pinch roll to set a pre-defined minimum separation for receiving the sheet material therebetween, the method including the following steps:
sensing vibration frequency in apparatus associated with said pinch rolls to generate an oscillating electric signal of corresponding frequency;
sensing tension established in said sheet material between said coiling mandrel and upstream feed rolls including said pinch rolls to generate a tension established signal;
monitoring said oscillating electric signal to ascertain whether it exceeds a predetermined threshold value when said tension established signal is positive, said threshold value being associated with excess vibration in the apparatus caused by the presence of a fault in the sheet material passing between the pinch rolls; and
generating an alert when said predetermined threshold value is exceeded.

9. Method according to claim 8, in which the separation between the pinch rolls is monitored.

10. Method according to claim 9, in which the presence of a fault in the sheet material is associated with a location on the sheet material, the location of the fault being associated with the separation between the pinch rolls and whether a tension established signal is generated.

11. Method according to claim 8 in which the oscillating electric signal generated is voltage.

12. Method according to claim 8 in which a sensor responsive to vibration frequency is mounted to a drive train for said moveable pinch roll to generate said oscillating electric signal.

13. System for detecting faults in sheet material which is generally uniform in thickness, the system including:
a) a sensor for coupling to apparatus associated with pinch rolls for receiving the sheet material therebetween, said sensor being responsive to vibration frequency in said apparatus to generate an oscillating electric signal of corresponding frequency when the thickness of the sheet material received between the pinch rolls exceeds specifications;
b) processing means for determining whether said oscillating electric signal exceeds a predetermined threshold value associated with the presence of a fault in the sheet material, and
c) an alert means for alerting maintenance personnel that the said predetermined threshold value has been exceeded.

14. A system according to claim 13 in which the sensor is an accelerometer.

15. A system according to claim 13 in which the electric signal generated is voltage.

16. System according to claim 13 in which the processing means forms part of a computing device.

17. System according to claim 13 in which the alert means includes a graphical display selected from the group consisting of:
visual display unit, and a plotter.

18. System according to claim 13 in which the alert means includes any one of the following:
an electronic messaging system, a visual alarm system, an audible alarm system.

19. System according to claim 13 including:
a) a tension sensor for sensing tension in the sheet material and to generate a tension established signal, said processing means being configured to generate an alert when the tension established signal is positive.

20. System according to claim 19 including means to monitor a separation between the pinch rolls, the pinch rolls including a moveable pinch roll moveable relative to a fixed pinch roll, said separation having a pre-defined minimum for receiving the sheet material therebetween, and said alert means being configured to display an alert which indicates a location for a fault in the sheet material, the location of the fault being associated with the separation between the pinch rolls and whether a tension established signal is generated.
